(19) United States
(12) Patent Application Publication
(10) Pub. No.: US 2015/0325343 A1
(43) Pub. Date: Nov. 12, 2015

(54) APPARATUS AND METHOD FOR PREVENTING ACCIDENTAL GROUND-FAULTS IN RESIDENTIAL ELECTICAL WIRING SYSTEMS

(71) Applicant: Albert Welsh, Loxahatchee, FL (US)

(72) Inventor: Albert Welsh, Loxahatchee, FL (US)

(21) Appl. No.: 14/704,913

(22) Filed: May 5, 2015

Related U.S. Application Data
(60) Provisional application No. 61/989,485, filed on May 6, 2014.

(51) Int. Cl. H01B 17/58; H01R 43/28; H01B 7/02

(52) U.S. Cl. CPC H01B 17/58; H01B 7/02; H01R 43/28

(57) ABSTRACT

A residential wiring system includes a non-metallic sheathed cable having insulated current carrying wires and an insulated grounding conductor. The ground wire may be insulated for the entire length of the sheath, or for only the end portions of the conductor. An insulating sleeve may be used to insulate a portion of the ground wire.

### BACKGROUND OF THE INVENTION

1. Field of Endeavor

The present invention relates to systems and methods for wiring in mostly residential buildings. More particularly, the invention relates to wiring systems, devices and methods that prevent accidental contacts between conductors causing ground-faults, short circuits, objectionable currents and dangerous situations.

2. Background Information

A ground wire acts as a “bypass” for currents in the event of a fault. Fixed (e.g. water heater, kitchen range) and portable corded appliances with extraneous metal which can be touched in normal use must be grounded. Protective ground conductors are necessary because of the danger of faults occurring internally in electrical devices. Appliances such as hair driers, TVs, some food processors etc. have plastic casings. If a fault occurs inside the appliance, e.g. a live or hot wire touches the inside of the casing or insulation becomes compromised, there is no danger to a person since the plastic body is an insulator. These appliances may not have a ground wire in the cord, which is plugged into a receptacle. Some appliances such as power tools are not grounded and instead are “doubly insulated”. This means that although the framework of the tool may be metal, sufficient separation and isolation of the external metal from internal high voltages is effected to prevent electric shock. These devices don't have a ground wire in the cord either. But residential wiring does require a ground wire to protect against faults.

A “ground-fault” is a condition that occurs when a current carrying (hot or live) conductor contacts ground or metal parts to create an unintended current path. The unintended current path represents an electrical shock hazard. A ground-fault may also result in fire. A ground-fault may occur for several reasons. If the wiring insulation within a load circuit becomes damaged, the hot conductor may contact ground or metal parts, creating a shock hazard for a user. A ground-fault may also occur when equipment comes in contact with water. A ground-fault may also be caused by damaged insulation within the electrical distribution system.

A ground-fault circuit interrupter (GFCI) is specifically designed to detect currents to ground. GFCIs differ from overcurrent devices (circuit breakers) because they detect much smaller currents. GFCIs are typically rated to interrupt leakages to ground that are greater than 6 mA. A charging circuit interrupting device (CCID) is a GFCI that trips at a predetermined threshold, 20 mA being typical. There are other devices, e.g., Ground-fault Equipment Protectors (GFEPs), which are configured to interrupt the circuit (to remove the fault) when the ground-fault is greater than 30 mA.

All of these devices serve to interrupt fault currents propagating in the ground circuit before the ground wire becomes overheated, or is compromised by an open circuit condition. An open grounding path from the equipment to the electric panel, therefore, represents an electrical shock hazard because in a ground-fault situation the current flowing in the grounding conductor cannot flow through the conductor back to the electric panel. Instead, the current will seek the best available path back to the electric panel and, unfortunately, the best available path back to the electric panel may include a human being. Accordingly, a device commonly referred to as a ground continuity monitor (GCM) may be employed to determine if the ground conductor is intact.

Various kinds of ground-fault interrupters are available. Ground-fault interrupters are designed to break the electrical circuit when a ground-fault is detected. A ground-fault interrupter measures the magnitude difference in current between the hot and neutral wires. In a normal operating situation, the ground-fault interrupter should measure zero difference.

Known ground-fault interrupters and monitoring devices are typically designed for use with a single circuit and are relatively expensive such that in residential application the use of ground-fault interrupters are often limited to higher risk areas such as bathrooms, kitchens and outside weatherproof receptacles.

Accidental ground-faults will trigger an interrupter or other devices and require an electrician to identify the source of the fault. The vast majority of detected faults are accidental, in that they do not involve the breakdown of insulation or other mechanical failure. The majority of accidental ground-faults in residential systems result from an uninsulated ground wire accidentally touching a powered (a/k/a a “hot” or “live”) wire or other powered object that is not damaged, but simply in close proximity to the ground wire.

Most wiring today in residential homes are wired with Nonmetallic Sheathed Cable w/uninsulated or bare grounding conductor. Nonmetallic Sheathed Cable w/uninsulated or bare grounding conductor comes in different sizes ranging from #2 AWG (American Wire Gauge) to #14 AWG and having at least two current carrying insulated conductors and one uninsulated or bare grounding conductor. Nonmetallic Sheathed Cable w/uninsulated or bare grounding conductor has been the preferred wiring method of residential homes since being introduced in the 1920's.

Since approximately 2002 the NEC (National Electric Code), has required using an Arc Fault Circuit Interrupter (AFCI) type Breaker in most circuits. If the bare or uninsulated grounding conductor touches the neutral (grounded conductor) screw of a receptacle the AFCI breaker trips causing you to locate the problem. This is more of an inconvenience than a danger to the electrical contractor or homeowner causing him or her unnecessary time and money to locate and repair the problem. The breaker will not reset until the receptacle is removed from the box and the bare or uninsulated grounding conductor is pushed away from the neutral (grounded conductor) screw on the receptacle. Most of the time, the problem is the bare grounding conductor touching the neutral (grounded conductor) screw.

Prior to the AFCI requirement, circuit breakers were required. These older circuit breakers, still in use today became standard in residences approximately in the early 1960's. Those circuit breakers would only trip when there was a ground-fault, meaning a live or hot wire was touching the uninsulated or bare grounding conductor or a short circuit where the live or hot wire was touching the grounded conductor (neutral). If the uninsulated or bare grounding conductor touches the insulated grounded conductor (neutral) screw on the receptacle you would never know there is a problem. When using the industry standard 3 prong tester it would indicate correct wiring. This problem creates a situation where the grounded conductor (neutral) and uninsulated or bare grounding conductor are now in parallel between the receptacle and the electrical panel and current would flow through both conductors creating what is called objectionable current.

There should never be current flowing on the uninsulated or bare grounding conductor. This creates a dangerous situation. This can cause a fire, shock or electrocution. The current will now flow equally on the insulated grounded conductor (neutral) and the bare or uninsulated grounding conductor, degrading on the resistance of each conductor. If the insulated grounded conductor (neutral) was to be cut, becomes detached from the receptacle or the grounded conductor (neutral) side of the receptacle becomes defective and does not allow current to no longer flow on the grounded conductor (neutral) from the receptacle back to the electrical panel the danger magnifies. This objectionable current will flow back to the electrical panel and throughout the residences uninsulated grounding conductors and under the right conditions can cause a fire, shock or electrocution. When the insulated grounded conductor (neutral) and the uninsulated or bare grounding conductor are in parallel current will flow on both the insulated grounded conductor (neutral) and the uninsulated grounding conductor at the same time. This can cause the circuit breaker in the electric panel not to trip during a ground-fault situation. Which in turn will allow the Nonmetallic Sheathed Cable to overheat and cause a fire.

In view of the foregoing, there is a need to prevent false, or accidental touching of the uninsulated or bare ground conductor to the other circuit conductors which are present or attachment devices, i.e. receptacles, switches. This accidental touching of the uninsulated or bare grounding conductor to the other existing circuit conductors can cause a fire, shock or electrocution. It is therefore desirable to provide a ground wire in Nonmetallic Sheathed Cable that does not cause false or accidental faults. This can be achieved by insulating the uninsulated or bare grounding conductor in Nonmetallic Sheathed Cable.

### BRIEF SUMMARY OF THE INVENTION

Accordingly, the primary object of the present invention is prevent accidental or false ground-faults and tripping arc-fault breakers in residential electric wiring systems.

In greater detail, the present invention prevents accidental ground-faults in nonmetallic sheathed cables and other devices used in residential wiring systems. A bare or uninsulated ground wire as commonly used in residential nonmetallic sheathed cables is exposed at each end of the cable. The neutral screws and the hot or live screws or the uninsulated or stripped sections of the conductors on the receptacle come into contact with the ground wire because the bare or uninsulated grounding conductor will be insulated. Thus accidental touching of a uninsulated or bare ground wire and a screw or uninsulated stripped sections of the insulated conductors attached to the receptacle or other devices is a no longer a problem.

In one embodiment, the invention provides an insulated ground wire in a non-metallic sheathed cable.

In another embodiment the invention provides a partial insulating sheath for use with a ground wire. The partial sheath may be retrofitted to existing ground wires.

These and other objects and advantages of the present invention will become apparent from a reading of the attached specification and appended claims. There has thus been outlined, rather broadly, the more important features of the invention in order that the detailed description thereof that follows may be better understood, and in order that the present contribution to the art may be better appreciated. There are features of the invention that will be described hereinafter and which will form the subject matter of the claims appended hereto.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a side view of a residential wiring system of the prior art;

FIG. 2 is a side view of a residential wiring system in accordance with the principles of the invention;

FIG. 3 is a side view of an alternative embodiment of a residential wiring system in accordance with the principles of the invention;

FIG. 4 is a side view of an alternative embodiment of a residential wiring system in accordance with the principles of the invention.

### DETAILED DESCRIPTION

Before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

The present invention provides apparatuses and methods for insulating the uninsulated or bare grounding conductor in nonmetallic sheathed cable or other devices, which is used primarily in residential wiring. It will prevent the bare or uninsulated grounding conductor from touching the uninsulated or stripped portions of the neutral grounded conductor and the hot, or live, conductor, and the screws to which they are attached. Thus, accidental touching of a uninsulated or bare grounding conductor and a screw or unstripped sections of conductors attached to receptacles or other devices may be prevented, thus preventing an accidental ground-fault.

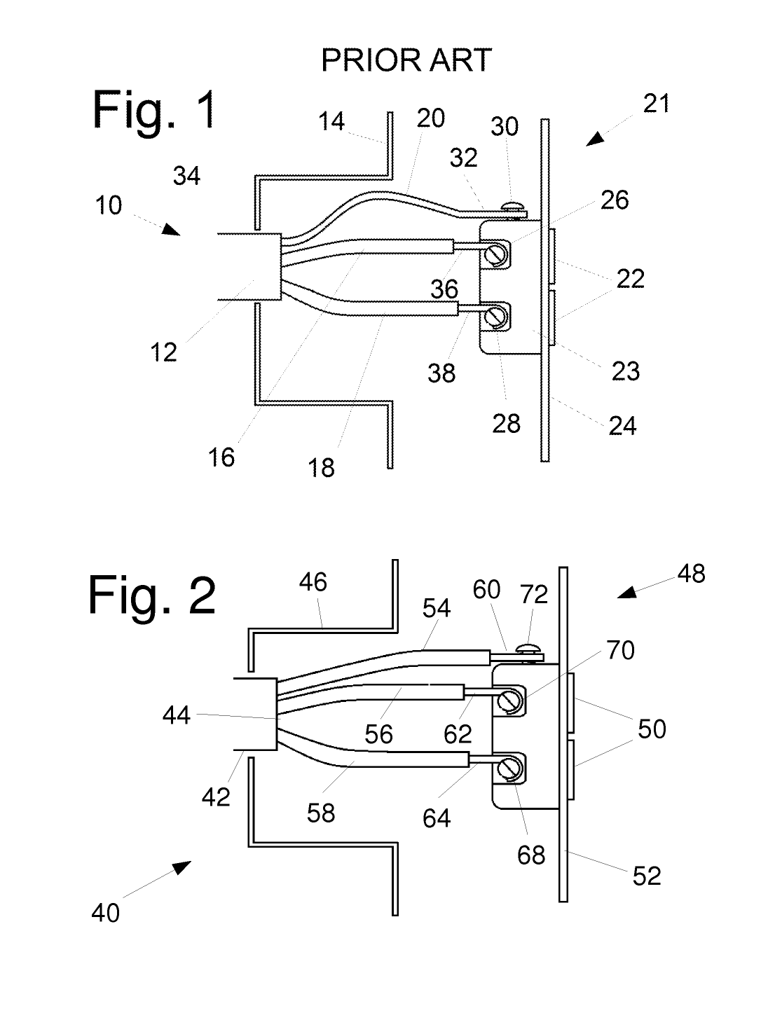

FIG. 1 shows a typical residential wiring system 10 of the prior art during installation of an electrical fixture 21. A nonmetallic sheath 12, usually formed from plastic or rubber, may contain electrical wires. In this example, the proximal end 34 of the non-metallic sheath 12 is located within a back box 14. A neutral wire 16, a live wire 18 and a ground wire 20 extend outward from the proximal end of the sheath 34. As used herein, the term “back box” refers to a standard back box commonly used with switches, sockets or other electrical devices found in residential wiring. It may also refer to any other housing where electrical connections are made during the installation of electrical wiring and electrical equipment.

An electronic fixture 21 includes a body 23 having a faceplate 24 with two electrical outlets 22. The body also includes a live screw 26, a neutral connecting screw 28 and a ground screw 30.

The three wires 16, 18 and 20 are typically pulled all the way through back box 14 so that an electrician may attach them to the neutral screw 26, live screw 28 and ground screw 30, respectively. Because the neutral wire 16 and the live wire 18 are insulated, there proximal ends must first be stripped to expose a live electrical contact region 36 and a neutral electrical contact region 38. Because ground wire 20 has no insulation, it is not necessary to strip the wire in order to expose its electrical contact region 32 at its proximal end.

The electrical contact regions 36, 38 and 32 of the wires are generally sized to allow for a solid connection to their respective screws 26, 28 and 30. Once the electrical contact regions have been attached to their respective screws, the electrical fixture 21 is pushed into the back box 14 so that the faceplate 24 may be attached to the back box 14, thus hiding the electrical connections. However, the action of pushing the fixture 21 into the back box 14 compresses the neutral wire 16, live wire 18 and the ground wire 20 into a very small, confined space. This may result in one or more wires coming into contact with other components. However, there is no way to know whether this is happened because there is no way to look inside the back box 14 while it is enclosed by faceplate 24. If the ground wire 20 comes into contact with screws 26 and 28 or the proximal ends 36 and 38 of the wires 16 and 18, objectionable current may travel through the ground wire 20. This may also result in an accidental ground-fault tripping a GFCI. As used herein, the term “electrical fixture” refers generally to a switch, electrical outlets, fans, lights, or other devices commonly wired electrically in a residential setting.

FIG. 2 shows a residential wiring system 40 in accordance with the present invention. In this embodiment, a non-metallic sheathed cable 42 has a proximal end 44 positioned inside a back box 46. An insulated live wire 58, insulated neutral wire 56 and an insulated ground wire 54 extend from the proximal end 44 of the cable 42. A fixture 48 may include a faceplate 52 having two sockets 50 and a body 51 having a live contact 68, a neutral contact 70 and a ground contact 72. All three wires are insulated and therefore must be stripped at their proximal ends to provide electrical contact regions 64, 62 and 60. These electrical contact regions 64, 62 and 60 are attached to screws 68, 70 and 72 respectively. Because the region of the ground wire between the stripped ground electrical contact region 60 and the proximal end 44 of the nonmetallic sheathed cable 42 is insulated, it is not able to come into electrical communication with the screws 68 and 70 or the electrical contact regions 64 and 62 of the live wire 58 and the neutral wire 56. As a result, the system 40 may not create an accidental ground-fault when the fixture 48 is pushed into the back box 46.

In this embodiment, the fixture 48 houses two sockets 22. However, the fixture may be any of several fixtures commonly attached to a back box, including for example a light switch, a light fixture, a fan or other electrically powered device. The back box 14 may similarly be any type of back box commonly used in residential wiring systems. This embodiment also uses screws as the contacts to connect the wires to the fixture. Those skilled in the art will appreciate that there are other mechanisms suitable for use as electrical contacts that may be used in place of screws. The nonmetallic sheathed cable 42 in this embodiment is of a type commonly referred to as a two wire cable because it includes two wires for transmission of electricity.

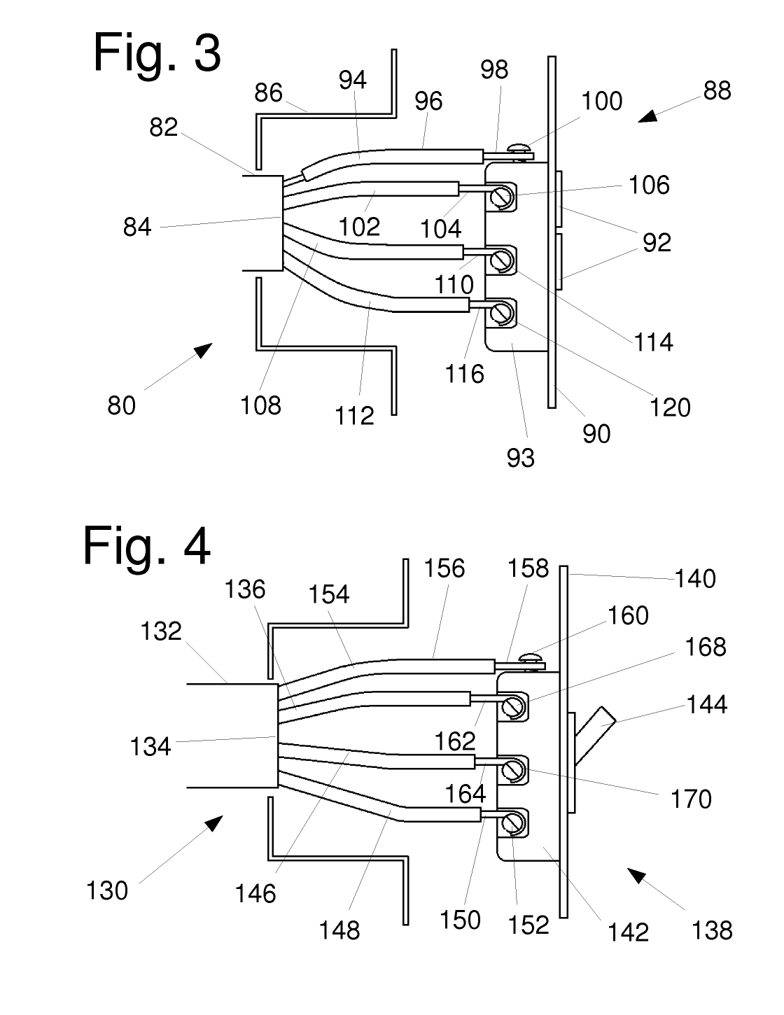

FIG. 3 shows an alternative embodiment 80 in accordance with the principles of the invention. In this embodiment, a non-metallic sheathed cable 82 has a proximal end 84 positioned inside a back box 86. In this embodiments, the nonmetallic sheathed cable 82 is of a type referred to as a three wire cable because it includes two live wires 108 and 112. Insulated live wires 108 and 112, insulated neutral wire 108 and an uninsulated ground wire 94 extend from the proximal end 84 of the cable 82. A fixture 88 may include a faceplate 90, sockets 92 and a body 93 having two live contacts 68, a neutral contact 70 and a ground contact 72. The live wires 108 and 112 and neutral wire 108 are manufactured with insulation and stripped to provide electrical contact regions 116 and 110, respectively. However, in this embodiments, the nonmetallic sheathed cable 82 includes a ground wire 94 manufactured without insulation. In this situation, an insulating sleeve 96 may be slid over the ground wire and positioned such that an electrical contact region 98 is formed at the proximal end of the ground wire 94. Thus, most of the region of the ground wire 94 in the back box 86 extending between the electrical contact region 98 and the cable end 84 may be insulated by the sleeve 96. The electrical contact regions 116, 110 and 104 are attached to screws 120, 114 and 106 respectively. Because the region of the ground wire between the exposed electrical contact region 60 and the proximal end 84 of the nonmetallic sheathed cable 82 is insulated, it is not able to come into electrical communication with the screws 120 and 114 or the electrical contact regions 116 or 110 of the live wire 58 and the neutral wire 56. As a result, the system 40 may prevent objectionable current in the ground wire 94 and may prevent an accidental ground-fault when the fixture 48 is pushed into the back box 46.

FIG. 4 shows an alternative embodiment 130 in accordance with the principles of the invention. In this embodiment, a non-metallic sheathed cable 132 has a proximal end 134 positioned inside a back box 136. In this embodiments, the nonmetallic sheathed cable 132 is of a type referred to as a three wire cable because it includes two live wires 146 and 148. Insulated live wires 146 and 148, insulated neutral wire 136 and an uninsulated ground wire 154 extend from the proximal end 134 of the cable 132. A fixture 138 may include a faceplate 140, a switch 144 and a body 142 having two live contacts 125 and 170, a neutral contact 168 and a ground contact 160. The live wires 146 and 148 and neutral wire 136 are manufactured with insulation and stripped to provide electrical contact regions 150 and 164, respectively. However, in this embodiment, the nonmetallic sheathed cable 132 includes a ground wire 154 manufactured without insulation. An insulating sleeve 154 may be slid over the ground wire and positioned such that an electrical contact region 158 is exposed at its proximal end. In this embodiment, the sleeve 156 is longer than the sleeve 96 shown in FIG. 3. Sleeve 156 extends along the length of the ground wire into the nonmetallic sheathed cable 132. Thus, all of the region of the ground wire 154 extending beyond the end 134 of the cable 132 up to the contact region 158 may be insulated by the sleeve 96. The electrical contact regions 158, 162, 164, and 150 are attached to contacts 160, 168, 170 and 152, respectively. Because the region of the ground wire between the exposed electrical contact region 158 and the proximal end 134 of the nonmetallic sheathed cable 132 is insulated, it is not able to come into electrical communication with the screws 120 and 114 or the electrical contact regions 116 or 110 of the live wire 58 and the neutral wire 56. As a result, the system 40 may prevent objectionable current in the ground wire 94 and may prevent an accidental ground-fault when the fixture 48 is pushed into the back box 46.

Whereas, the present invention has been described in relation to the drawings attached hereto, it should be understood that other and further modifications, apart from those shown or suggested herein, may be made within the spirit and scope of this invention. Descriptions of the embodiments shown in the drawings should not be construed as limiting or defining the ordinary and plain meanings of the terms of the claims unless such is explicitly indicated.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

1. A residential wiring system comprising:
at least one powered conducting wire;
at least one neutral conducting wire;
at least one ground conducting wire; and,
a non-metallic sheath housing the at least one powered wire and the at least ground wire;
wherein the ground wire is surrounded by an insulating jacket.

2. The residential wiring system of claim 1 wherein the ground wire is insulated for the same length as the at least one powered wire.

3. The residential wiring system of claim 1 wherein the ground wire is insulated only at the ends of the wiring system.

4. A method of preventing false tripping of an arc-fault breaker in a residential wiring system comprising:
inserting into a back box a proximal end of a non-metallic sheathed cable, wherein an insulated live wire, an insulated neutral wire and an uninsulated ground wire protrude from a proximal end of the non-metallic sheathed cable;
providing an electric fixture having a live contact, a neutral contact and a ground contact;
stripping the insulation off a proximal end of the live wire to form a live contact region;
stripping the insulation off a proximal end of the neutral wire to form a neutral contact region;
connecting the live contact region to the live contact;
connecting the neutral contact region to the neutral contact;
sliding an insulating sheath over the ground wire such that a ground contact region is exposed at its distal end and most or all of the ground wire within the back box is insulated;
connecting the ground wire to the ground contact;
pushing the fixture into the back box and securing it therein.
